(19) United States
(12) Patent Application Publication
(10) Pub. No.: US 2013/0084412 A1
(43) Pub. Date: Apr. 4, 2013

(54) ORNAMENTAL DEVICES WITH INTERCHANGEABLE DECORATIVE PIECES

(71) Applicant: Garth Robert Parker, Irvine, CA (US)

(72) Inventor: Garth Robert Parker, Irvine, CA (US)

(21) Appl. No.: 13/248,601

(22) Filed: Sep. 29, 2011

(51) Int. Cl. F16B 5/07

(52) U.S. Cl. 428/33

(57) ABSTRACT

An ornamental device including a base and interchangeable decorative pieces is disclosed herein. The base and interchangeable decorative pieces may be coupled to one another via a slide joint. The base includes a ring band on a bottom surface and a protrusion or notch on a top surface. The decorative pieces include a corresponding notch or protrusion configured to slideably mate with the protrusion or notch on the top surface of the base. The base and interchangeable decorative pieces may have a size greater than a 1.25 and/or 1.75 inch diameter choke tube allowing the ornamental device to have a zero age grade rating.

### FIELD

In general, the disclosure relates to ornamental devices. More particularly, the disclosure relates to ornamental devices including decorative components.

### BACKGROUND

In general, a number of different toy rings and other jewelry have been developed. Many of these rings are developed and designed to target specific child interests, such as depicting characters from television shows and movies, or holiday type rings, for Christmas and Halloween. In one example, plastic toy rings designed for Halloween may include rings having bats, skulls, witches, pumpkins, and other designs on them, and may be sold or given out in October. Plastic toy rings designed for Christmas may include rings having Santa Claus heads and/or hats on them, and may be sold or given out in December.

These toy rings may also be used as decorative pieces and/or given out at parties, such as a child's birthday party. For example, toy rings may be placed on top of cupcakes and other birthday party pastries and cakes. However, these toy rings are typically one piece plastic rings. Further, these toy rings may be small in size and can present a choking hazard for children under a certain age.

### SUMMARY

An ornamental device including a base and interchangeable decorative pieces is disclosed herein. The base and interchangeable decorative pieces may be coupled to one another via a slide joint.

In one embodiment, the base may include a protrusion on a top surface, and the decorative pieces may include a corresponding notch configured to slideably mate with the protrusion on the top surface of the base. In another embodiment, the base may include a notch or groove on a top surface, and the decorative pieces may include a corresponding protrusion configured to slideably mate with the notch or groove on the top surface of the base.

The protrusion or notch on the decorative pieces may be positioned to allow the decorative pieces to be vertically or horizontally oriented when the decorative pieces are mated with the base. Further, the base and interchangeable decorative pieces may have a size greater than a 1.25 and/or 1.75 inch diameter choke tube allowing the ornamental device to have a zero age grade rating and be suitable for people/children of all ages.

In an illustrative embodiment, the base may be attached to or include a ring band, bracelet, necklace, earring, headband, head piece, belt, belt buckle, hair pin and/or clasp, or pin and/or broach. Generally, the decorative pieces are slideably removable, allowing them to be interchanged. For example, children can collect and/or trade different decorative pieces, and change which decorative piece is placed on or coupled to the base at any time to change the look and design of the ornamental device allowing the ornamental device to be customized.

### BRIEF DESCRIPTION OF THE DRAWINGS

The ornamental devices disclosed herein are illustrated in the figures of the accompanying drawings which are meant to be exemplary and not limiting, in which like references are intended to refer to like or corresponding parts, and in which:

FIG. 1 illustrates a side view of an embodiment of an ornamental ring having a horizontal decorative portion;

FIG. 2 illustrates a side view of a base portion of the ornamental ring of FIG. 1;

FIG. 3 illustrates a top view of the base portion of the ornamental ring of FIG. 1;

FIG. 4 illustrates a side view of the horizontal decorative portion of the ornamental ring;

FIG. 5 illustrates a bottom view of the horizontal decorative portion of the ornamental ring of FIG. 1;

FIG. 6 illustrates a top view of the horizontal decorative portion of the ornamental ring of FIG. 1;

FIG. 7 illustrates a side front view of another embodiment of an ornamental ring having a vertical decorative portion of FIG. 1;

FIG. 8 illustrates a side front view of a base portion of the ornamental ring having the vertical decorative portion of FIG. 7;

FIG. 9 illustrates a side view of the base portion of the ornamental ring having the vertical decorative portion of FIG. 7;

FIG. 10 illustrates a top view of the base portion of the ornamental ring having the vertical decorative portion of FIG. 7;

FIG. 11 illustrates a side front view of the vertical decorative portion of the ornamental ring of FIG. 7; and

FIG. 12 illustrates a side view of the ornamental ring having the vertical decorative portion of FIG. 7.

### DETAILED DESCRIPTION

Detailed embodiments of the present ornamental devices are disclosed herein, however, it is to be understood that the disclosed embodiments are merely exemplary of the ornamental devices, which may be embodied in various forms. Therefore, specific functional details disclosed herein are not to be interpreted as limiting, but merely as a basis for the claims and as a representative basis for teaching one skilled in the art to variously employ the present disclosure.

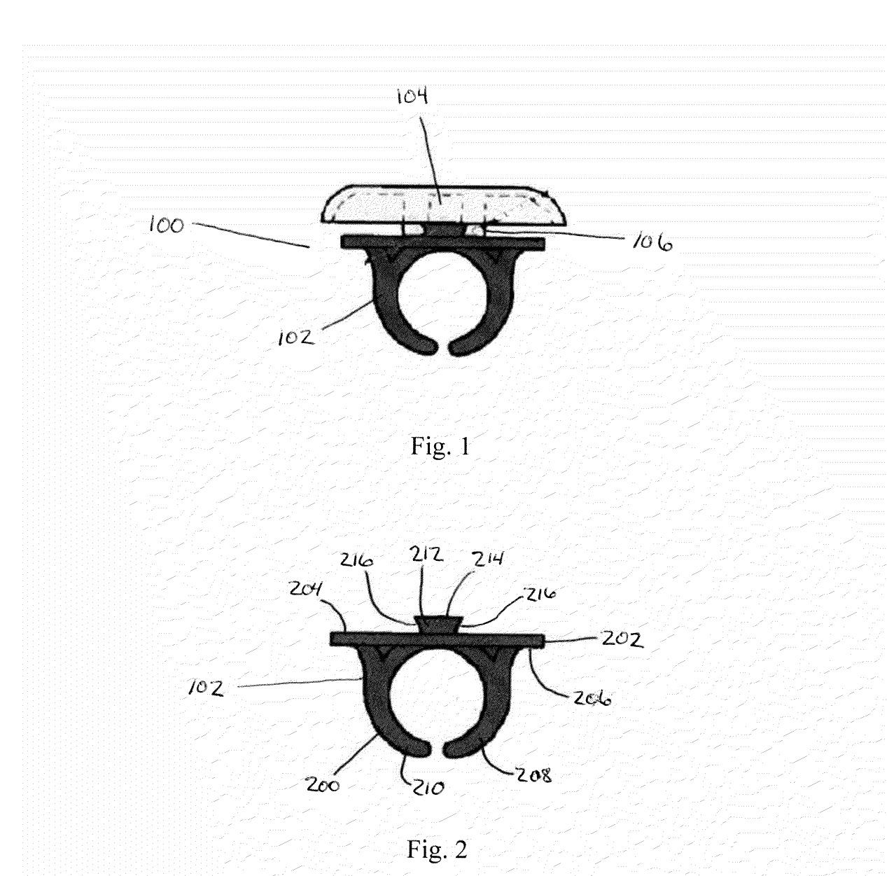

An ornamental device according to a first illustrative embodiment is described with reference to FIGS. 1-6. As illustrated in FIG. 1, the ornamental device is a ring 100. The ring 100 includes a base 102 and a horizontally oriented decorative and/or ornamental piece or portion 104. The decorative portion 104 may be attached to and removed from the base or ring portion 102. In an illustrative embodiment, the decorative portion 104 and the base 102 are connected by one or more joints 106. The joint(s) 106 may be a slide joint, a slider, a prismatic joint, or other joint of the type.

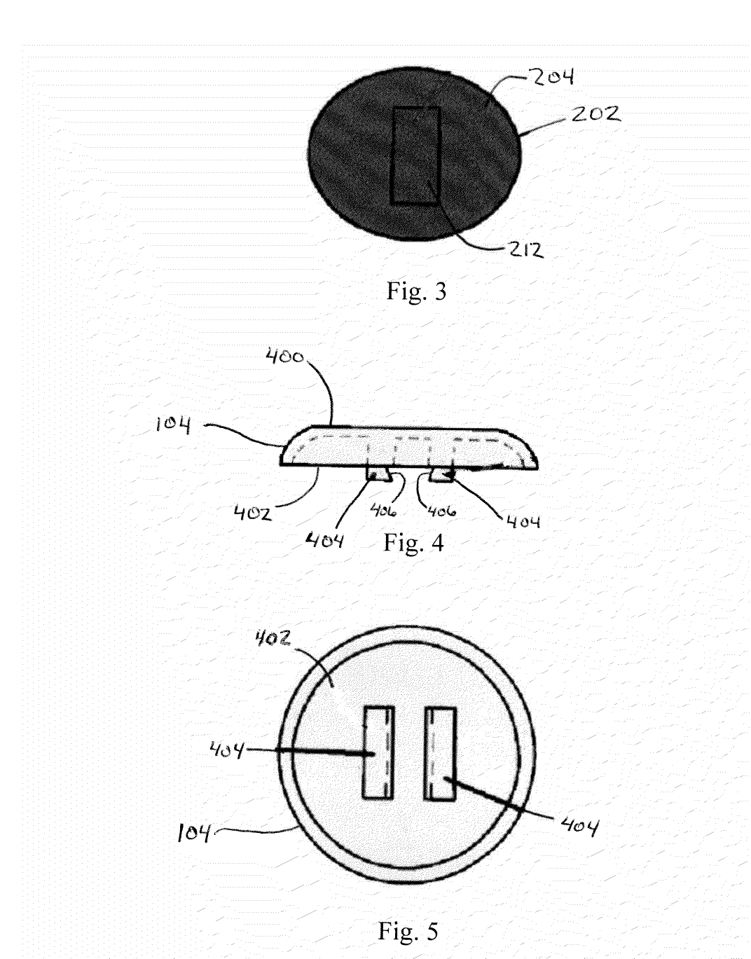

The base 102 of the ornamental device according to an illustrative embodiment is described with reference to FIGS. 2 and 3. As illustrated, the base 102 may include a band portion 200 and a head portion 202. The head portion 202 includes a top surface 204 and a bottom surface 206. The band portion 200 may be fastened to, attached to, connected to, integrated with, and/or monithically formed as a single piece with the head portion 202, and is positioned on the bottom surface 206 of the head portion 202. In an illustrative embodiment, the band portion 200 may be glued using an adhesive. Alternatively, it may be fastened to the head portion 202 using screws, bolts, nails or other fasteners, or it may be molded, and/or sonic or ultrasonic welded, or the like.

As illustrated, the band portion 200 has a split band design, wherein the band portion 202 includes two semi-circular prongs 208 and 210 that are disconnected from each other opposite the head portion 202. The split band design allows for a one size fits all design, wherein the prongs 208 and 210 may bend or flex to accommodate varying sizes of one or more persons fingers. Typically, the base 102 is made of a durable material that allows the prongs 208 and 210 to flex and accommodate different sizes of fingers without breaking, for example high impact polystyrene (HIPS). However, other materials may be used, such as but not limited to metals, other polymers, plastics, PVC (Polyvinyl chloride), NPPVC, ABS (acrylonitrile butadiene styrene), PP (polypropylene), Nylon, woods, and/or any other material of the type.

In an illustrative embodiment, the base 102 includes at least one protrusion or slide post 212. As illustrated in FIGS. 2 and 3, the slide post 212 protrudes vertically upward from and is centrally positioned on the top surface 204 of the head portion 202. In this embodiment, the slide post 212 forms a male portion of the joint 106. The slide post 212 may have a cross-section in the shape of a trapezoid, having a top abutment surface 214, side abutment surfaces 216, and a bottom defined by the top surface 204 of the head portion 202. The top abutment surface 214 has a width greater than the bottom that is defined by the top surface 204 of the head portion 202. This allows the decorative portion 104 to mate with the slide post 212 and form a friction fit substantially preventing the decorative portion 104 from being vertically removed from the base 102.

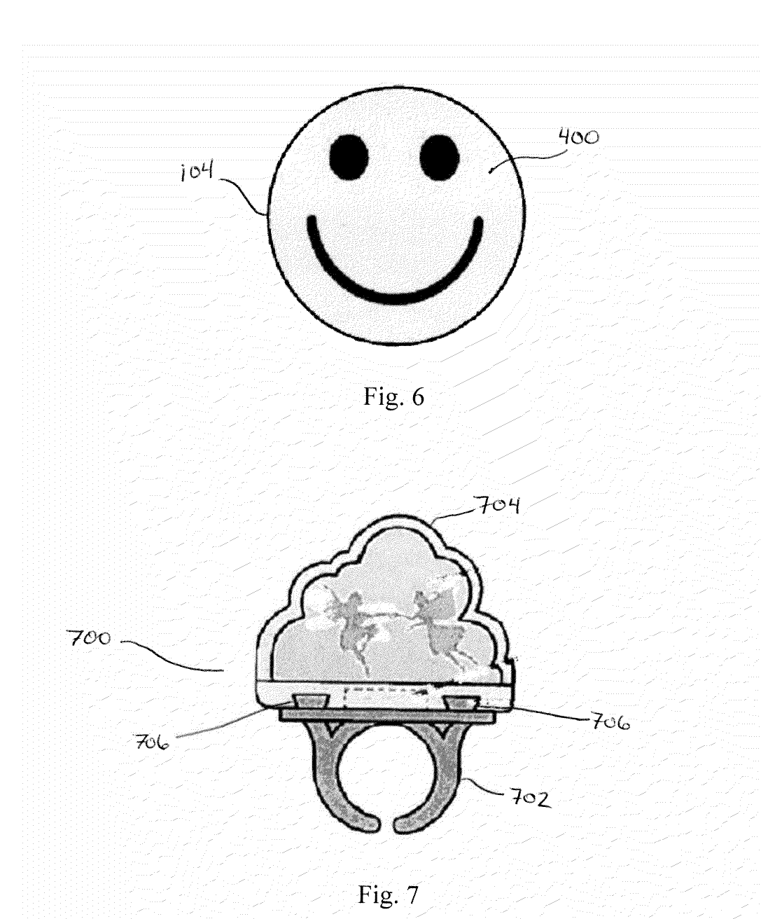

The decorative portion 104 of the ornamental device according to an illustrative embodiment is described with reference to FIGS. 4-6. In this embodiment, the decorative portion 104 has a substantially flat profile and is circular in shape. The decorative portion 104 includes a top decorative surface 400 and a bottom surface 402. As illustrated in FIG. 6, the top decorative surface 400 includes a decorative design, for example a face or smiley face. However, it should be appreciated that the top decorative surface 400 may include any type of design, picture, message, or other decorative surface that may be adhered to, painted and/or drawn on, molded with, and/or imprinted on the top decorative surface 400. Similar to the base 102, the decorative portion 104 may be made of a durable material, for example high impact polystyrene (HIPS). However, other materials may be used, such as but not limited to metals, other polymers, plastics, PVC (Polyvinyl chloride), NPPVC, ABS (acrylonitrile butadiene styrene), PP (polypropylene), Nylon, Vinyls, paper, lenticular films, woods, and/or any other material of the type.

Referring to FIGS. 4 and 5, the decorative portion 104 may include one or more protrusions or clasp posts 404. In this embodiment, the clasp posts 404 protrude substantially perpendicularly downward from and are centrally positioned on the bottom surface 402 of the decorative portion 104. In this embodiment, the clasp posts 404 form a female portion of the joint 106, and are configured to mate with the slide post 212 on the base 102. As illustrated, the clasp posts 404 include interior side abutment surfaces 406. The interior side abutment surfaces 406 of the clasp posts 404 are angled to be closer to each other distal to the bottom surface 402 of the decorative portion 104, and further away from one another proximal to the bottom surface 402 of the decorative portion 104. The clasp posts 404 and interior side abutment surfaces 406 form an aperture, notch, or groove having a cross-section in the shape of a trapezoid, slightly larger than the size of the slide post 212. The interior side abutment surfaces 406 are configured to engage with the side abutment surfaces 216 of the slide post 212 to facilitate a loose friction fit. For example, the decorative portion 104 may be removably coupled to the base 102 by sliding or moving the decorative portion 104 and the base 102 along a single axis relative to one another, thereby engaging or mating with the side abutment surfaces 216 of the slide post 212 with the interior side abutment surfaces 406 of the clasp posts 404.

Another ornamental device according to an illustrative embodiment is described with reference to FIGS. 7-12. As illustrated in FIG. 7, the ornamental device is a ring 700. The ring 700 includes a base 702 and a vertically oriented decorative and/or ornamental piece or portion 704. Similar to the embodiment described above, the decorative portion 704 may be removably attachable to the base 702 by one or more joints 706. The joint(s) 706 may be a slide joint, a slider, a prismatic joint, or other joint of the type.

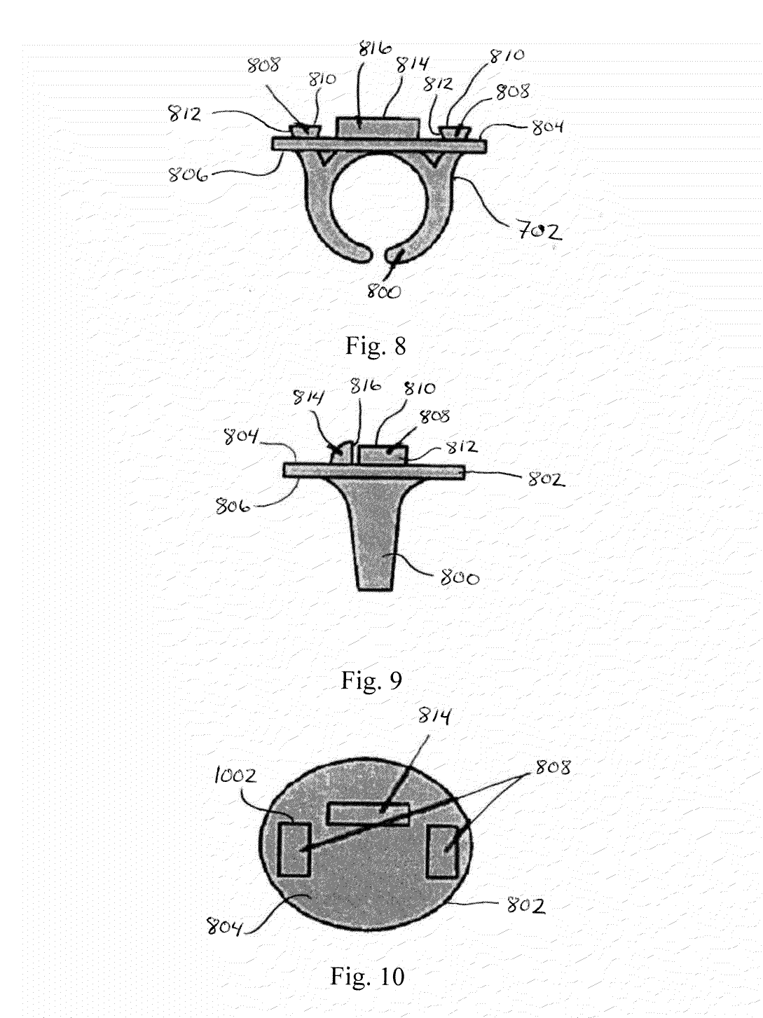

The base 702 of the ornamental device according to an illustrative embodiment is described with reference to FIGS. 8-10. As illustrated, the base 702 includes a band portion 800 and a head portion 802. The head portion 802 includes a top surface 804 and a bottom surface 806. The band portion 800 may be fastened to, attached to, connected to, integrated with, and/or monithically formed as a single piece with the bottom surface 806 of head portion 802, as described above. The base 702, may be substantially similar to the base 102 described above.

In this illustrative embodiment, the base 702 includes two protrusions or slide posts 808. As illustrated in FIGS. 8-10, the slide posts 808 protrude vertically upward from the top surface 804 of the head portion 802. In this embodiment, the slide posts 808 are parallel to one another and positioned on opposite sides of the top surface 804 of the head portion 802. The slide posts 808 form male portions of the joints 706. The slide posts 808 may have a cross-section in the shape of a trapezoid, as described above, having top abutment surfaces 810, side abutment surfaces 812, and bottoms defined by the top surface 804 of the head portion 802.

The base 702 may also optionally include at least one wall or stop 814. The stop 814 may be perpendicular to the slide posts 808 and positioned equidistant from each of the slide posts 808 on the top surface 804 of the head portion 802. Referring to FIG. 10, the stop 814 may also be substantially aligned with or slightly offset from ends 1002 of the slide posts 808. The stop 814 includes an abutment surface 816 proximal to the slide posts 808 for engaging the decorative portion 704. The stop 814 may also be positioned and configured to center the decorative portion 704 on the base 702 when the decorative portion 704 is coupled to the base 702.

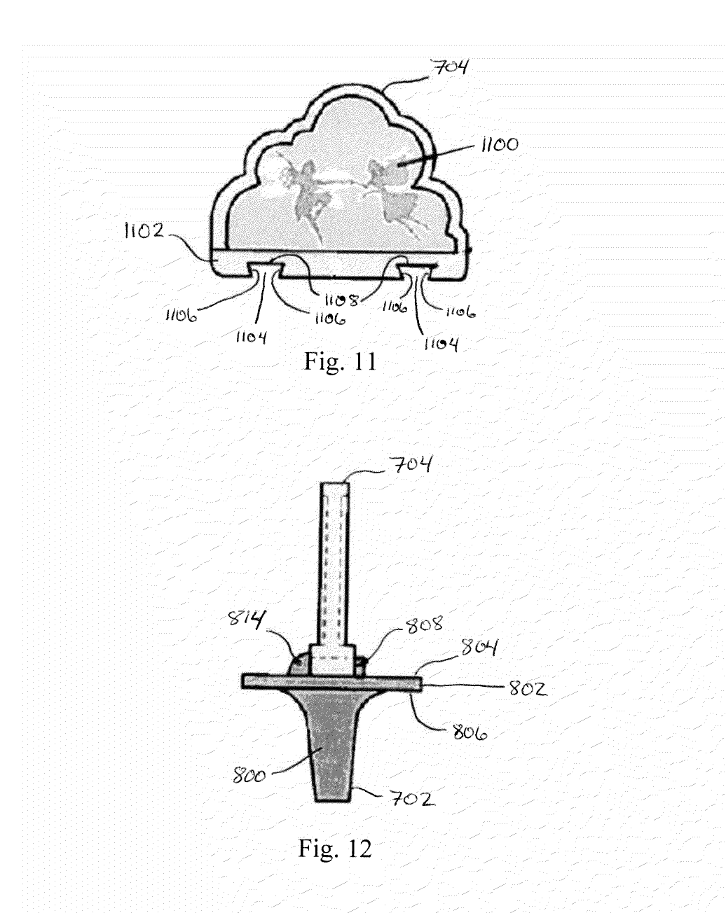

The decorative portion 704 of the ornamental device according to an illustrative embodiment is described with reference to FIG. 11. In this embodiment, the decorative portion 704 has a vertical profile. The decorative portion 704 includes a front decorative face 1100 and a back decorative face (not shown). As illustrated in FIG. 11, the front decorative face 1100 includes a decorative design, for example a picture and/or other decorative design, adhered to, painted and/or drawn on, molded with, and/or imprinted on the front decorative face 1100 and/or a back decorative face. However, it should be appreciated that the front decorative face 1100 may include any type of design, picture, message, or other decorative surface. Further, the decorative portion 704 may be made of the materials listed above in reference to the decorative portion 104.

The decorative portion 704 further includes a bottom end 1102. The bottom end 1102 may include one or more notches or grooves 1104. Typically, the notches 1104 are positioned on the bottom end 1102 of the decorative portion 704 at positions corresponding to the positions of the slide posts 808 on the top surface 804 of the head portion 802. In this embodiment, the notches 1104 form female portions of the joints 706, and are configured to mate with the slide posts 808 on the base 702. As illustrated, the notches 1104 include interior side abutment surfaces 1106 and top abutment surfaces 1108. The interior side abutment surfaces 1106 of the notches 1104 are angled to be closer to each other at an edge of the bottom end 1102 of the decorative portion 704, and further away from one another as the interior side abutment surfaces 1106 extend vertically upward. The notches 1104 and interior side abutment surfaces 1106 form an aperture or groove having a cross-section in the shape of a trapezoid, slightly larger than the size of the slide post 808. The interior side abutment surfaces 1106 and top abutment surface 1108 are configured to engage with the side abutment surfaces 812 and top abutment surfaces 810 of the slide post 808, respectively.

As illustrated in FIG. 12, the decorative portion 704 may be removably coupled to the base 702 by sliding or moving the decorative portion 704 and the base 702 along a single axis relative to one another, thereby engaging or mating with the side abutment surfaces 812 and top abutment surfaces 810 of the slide post 808 with the interior side abutment surfaces 1106 and top abutment surface 1108 of the notches 1104. The decorative portion 704 may be slid onto the base 702 to engage the abutment surface 816 of the stop 814, substantially preventing the decorative portion 704 from being slid completely past the slide post 808 and off of the base 702. The stop 814 may also be positioned to allow the decorative portion 704 to be centered on the base 702 when the decorative portion 704 is engaged with the abutment surface 816 of the stop 814.

While, the embodiments described above have the male portion(s) of the slide joint, such as the slide post(s), on the base(s) and the female portion(s) of the slide joint, such as the clasp posts, notches or grooves, on the decorative portion(s), the male portion(s) of the slide joint may be located on the decorative portion(s) and the female portion(s) of the slide joint may be located on the base(s). Further, the ornamental rings 100 and 700 may have the same slide joints to allow the horizontal and vertical decorative portions to be interchangeable on a single base. The shape of the slide joint, including the slide post(s) and corresponding notches or grooves may have any cross-sectional shape, including but not limited to a trapezoid shape, a circular or oval shape such as a semicircular or oval shape and a more than half circular or oval shape, a triangular shape, a polygon shape, a flower type shape, and other geometrical shape of the type.

The male and female portions of the joint or slide joint on the base and decorative portion may be positioned to be centrally located on the base and/or decorative portion, located closer to an edge of the base and/or decorative portion, or located at any position on the base and/or decorative portion so long as the portions of the joint or slide joint on the base and decorative portion correspond to one another allowing the base and decorative portion to be coupled together. There may also be one, two, three, or any number of male and female portions of the joint or slide joint on the base and decorative portion.

While the decorative portions have been described and illustrated in connection with certain embodiments, the decorative portions may have any of various sizes, shapes, colors, or decorative design. The decorative portions are removable, allowing them to be interchanged. For example, children can collect and/or trade different decorative portions, and change which decorative portion is placed on the base at any time to change the look and design of the ornamental device.

The band portion(s) of the base(s) may have a split band design, as described above, or other type of band design. Other types of band designs include but are not limited to a solid band design having a fixed size, stretch band designs that allow the band to stretch to accommodate different sizes of fingers, string or ribbon band designs that may include two ribbons anchored to the base at one end and free on the other end designed to be tied onto a finger allowing the band to accommodate different sizes of fingers, and other band designs of the type.

While the ornamental devices have been described and illustrated in connection with certain ring type embodiments, the joint or slide joint including the interchangeable decorative portions may be integrated into bracelets, necklaces, earrings, headbands, head pieces, belts and belt buckles, hair pins and/or clasps, pins and/or broaches, and other types of decorative/ornamental devices of the type having one or more interchangeable decorative portions. For example, instead of having a band portion (i.e. the portion where the finger is inserted in the ring embodiments) the base may be integrated with one or more of the different ornamental devices listed above.

In an illustrative embodiment, the ornamental devices, including each of the base portion(s) and decorative portion(s), may have a size large enough to minimize a choking hazard for children. The base portion(s) and decorative portion(s) may have a size greater than a 1.25 and/or 1.75 inch diameter choke tube preventing the base portion(s) and decorative portion(s) from being inserted into the 1.25 and/or 1.75 inch diameter choke tube in any orientation. Thus, allowing the ornamental devices to be suitable for children of all ages (i.e. having a zero age grade rating).

While the ornamental devices have been described and illustrated in connection with certain embodiments, many variations and modifications will be evident to those skilled in the art and may be made without departing from the spirit and scope of the disclosure. The disclosure is thus not to be limited to the precise details of methodology or construction set forth above as such variations and modification are intended to be included within the scope of the disclosure.

1. A toy, comprising:
a base having a top surface and a bottom surface;
at least two protrusions on said top surface of said base, said at least two protrusions including at least one of a mating protrusion or an abutment protrusion;
a decorative portion including at least one of a picture, a message, and a shape of a character adapted to target a child's interest; and
a mating feature on said decorative portion configured to mate with at least one of said at least two protrusions on said base.

2. The toy of claim 1, wherein said mating feature is a notch and said decorative portion is configured to be vertically oriented with respect to said base when said notch is mated with said at least one of said at least two protrusions.

3. The toy of claim 1, wherein said mating feature is a notch and said decorative portion is configured to be horizontally oriented with respect to said base when said notch is mated with said at least one of said at least two protrusions.

4. The toy of claim 1, further comprising a band portion on said bottom surface of said base.

5. The toy of claim 4, wherein said band portion includes two semi-circular prongs.

6. The toy of claim 1, wherein said at least one of said at least two protrusions and said mating feature have a cross-sectional shape selected from the group consisting of a trapezoid, a semicircle, a more than half circle, a semioval, a more than half oval, a triangle, and a polygon.

7. The toy of claim 1, wherein said at least one of said at least two protrusions and said mating feature form a slide joint.

8. The toy of claim 1, wherein each of said base and said decorative portion have a size configured to prevent each of said base and said decorative portion from being inserted into a 1.25 inch diameter choke tube.

9. The toy of claim 1, wherein each of said base and said decorative portion have a size configured to prevent each of said base and said decorative portion from being inserted into a 1.75 inch diameter choke tube.

10. A toy for use with a removable decorative piece, comprising:
a base having a top surface and a bottom surface, said top surface configured to slideably mate with said decorative piece; and
a stop having an abutment surface on said top surface of said base configured to engage said decorative piece.

11. The toy of claim 10, wherein said top surface of said base further includes a protrusion configured to mate with a notch in said decorative piece.

12. The toy of claim 10, wherein said top surface of said base further includes a notch configured to mate with a protrusion on said decorative piece.

13. The toy of claim 10, wherein said base further includes a band on said bottom surface of said base.

14. The toy of claim 10, wherein said base is sized to prevent said base from being inserted into a 1.75 inch diameter choke tube.

15. An interchangeable toy for use with a base, comprising:
plastic decorative piece including at least one of a picture, a message, and a shape of a character adapted to target a child's interest;
a mating feature in said plastic decorative piece configured to slideably mate with said base, said plastic decorative piece adapted to engage a stop having an abutment surface on said base when said mating feature is mated with said base.

16. The toy of claim 15, wherein said mating feature includes a protrusion configured to mate with a notch in said base.

17. The toy of claim 15, wherein said mating feature includes a notch configured to mate with a protrusion on said base.

18. The toy of claim 15, wherein said decorative piece is configured to be vertically oriented with respect to said base when mated with said base.

19. The toy of claim 15, wherein said decorative piece is configured to be horizontally oriented with respect to said base when mated with said base.

20. The toy of claim 15, wherein said decorative piece is sized to prevent said decorative piece from being inserted into a 1.75 inch diameter choke tube.
